(19) United States
(12) Patent Application Publication
(10) Pub. No.: US 2004/0024727 A1
(43) Pub. Date: Feb. 5, 2004

(54) Method and system of re-sharing files with modifications

(75) Inventor: Don Bowman, Waterloo (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Sandvine Incorporated, Waterloo (CA)

(21) Appl. No.: 10/207,154

(22) Filed: Jul. 30, 2002

(51) Int. Cl. G06F 7/00

(52) U.S. Cl. 707/1

(57) ABSTRACT

The invention discloses a method and system for dynamically modifying files in a shared file network, such as Peer to Peer network. Files may be modified by inserting advertising into the file before passing it on to the end user. Files may be modified to create audible artifacts thus making them less likely to be copied by an end user. The audible artifacts may be removed should the user pay a licensing fee for the file. Files may also be modified to add digital rights management information so that the file may not be utilized without the appropriate key. Files may also be modified by inserting tracking information to include such information as the date of download and the IP address of the site providing the file.

### BACKGROUND OF THE INVENTION

Files are often shared on the Internet with little regard for copyright holder rights. This sharing may be via the World Wide Web (WWW), File Transfer Protocol (FTP), peer-to-peer file sharing, and other means. Currently the only recourse a copyright rights holder has is to apply for court injunctions to prevent unlicensed distribution of their property. It is very difficult and costly to obtain such injunctions against an individual user who downloads a movie, image, song or other copyrighted material. At the time of filing this application, the copyright holders are directing their infringement charges to the intermediary software providers that facilitate the distribution of the material. Such intermediary providers would not only be those that provide services such as KaZaA, Morpheus and Napster but also the Internet Service Providers (ISPs) that support such services.

In addition to dealing with copyright issues, rights holders may also wish to modify the material as it is distributed for a variety of reasons. For example, a rights holder may wish to add advertising material to the file to help them recover the costs of distribution. They may wish to add targeting information to the material to aid them in tracking the material for marketing analysis or other statistical uses. Further, a rights holder may wish to add Digital Rights Management (DRM) information to the material.

Thus there is a need for a system to dynamically modify files transferred within a network for a variety of reasons. The present invention addresses this need.

### SUMMARY OF THE INVENTION

The present invention is directed to a file modification device for dynamically modifying content as the content transfers through a network.

The present invention is further directed to a method of dynamically modifying content as the content transfers through a network, the method having the steps of:

a) examining the content;

b) determining if a modification to the content is required;

c) if a modification is required, selecting the type of modification and performing the modification selected to create modified content;

d) outputting the content or the modified content.

### BRIEF DESCRIPTION OF THE DRAWINGS

For a better understanding of the present invention, and to show more clearly how it can be carried into effect, reference will now be made, by way of example only, to the accompanying drawings in which:

FIG. 1 is a block diagram of data flow within a network;

FIG. 2 is a logical flowchart of the overall process of the present invention;

FIG. 3 is a logical flowchart illustrating insertion of an advertisement in an audio file;

FIG. 4 is a logical flowchart illustrating audio quality reduction;

FIG. 5 is a logical flowchart illustrating insertion of digital rights management; and

FIG. 6 is a logical flowchart illustrating insertion of tracking information.

### DETAILED DESCRIPTION OF THE INVENTION

The present invention does not block the sharing of files, but rather modifies the files as they cross the network. One method of modification is to provide advertising, thus providing the content of the file with advertising support much like radio or television transmissions. Another method of modification would be to provide digital rights management, so that a fee would have to be paid so that the downloaded file may be used fully. Other modification mechanisms may include personalizing a file as it is downloaded in order to track it as it is redistributed. Such tracking information may be useful beyond the legal issues, for example to monitor use for marketing efforts.

In a peer-to-peer network, a device installed in the network may monitor file exchanges. An example of such a device is disclosed in the applicant's co-pending application titled “Path Optimizer For Peer To Peer Networks”, application Ser. No. 10/138,336, filed on May 6, 2002, the entire contents of which are incorporated herein by reference. Such a device, might instead of blocking a known stolen file, modify the contents of the file to lower the quality, thus rendering it less desirable.

This content modification may be reversible by paying a fee for the file, thus providing digital rights management and monetary flow back to the rights holder. In a web-based model, this network-based device would be similar to a web-cache.

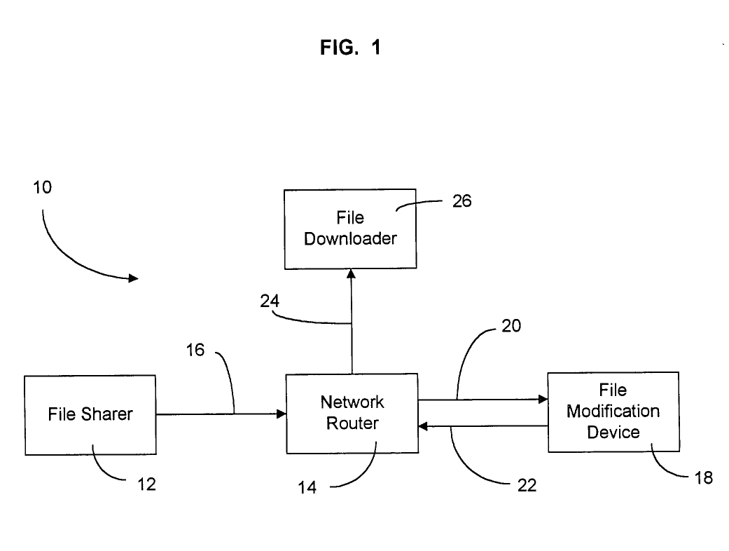

Referring now to FIG. 1 a block diagram of data flow within a network is shown generally as 10. File Sharer 12, for example a computer executing a peer-to-peer file sharing application, sends a requested file via link 16 to network router 14. Router 14 transfers the file to file modification device 18 via link 20. File modification device 18 makes the appropriate changes to the file, and passes it back to network router 14 via link 22. Network router 14 then forwards the file via link 24 to file downloader 26 where the file is received by the original requester. It is not the intent of the inventor to restrict the present invention to the network topography shown in FIG. 1; this is simply one example of how the present invention may be utilized.

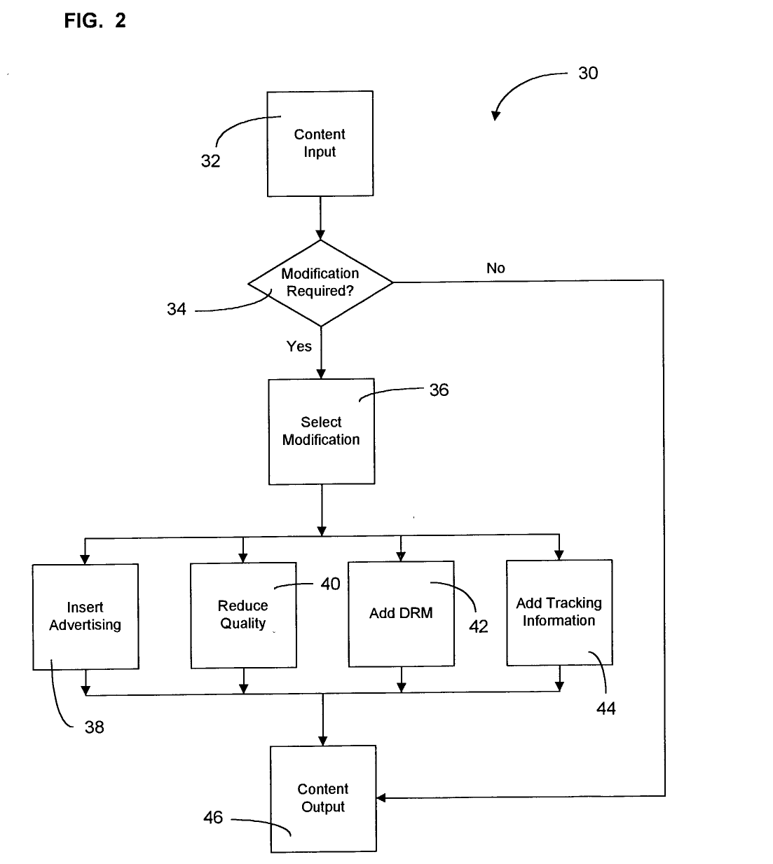

Referring now to FIG. 2 a logical flowchart of the overall process of the present invention is shown generally as 30. Process 30 would be utilized in file modification device 18 of FIG. 1. Content is received at step 32. Content may be any form of material that the rights holder may wish to protect. Examples include, but are not limited to: single images or streaming video, sound files, and text files. At step 34 a test is made to determine if a modification to the content is required. Determining if a modification is required requires the recognizing of content. This may be done by file name, matching patterns in the content, computing content signatures, by associated metadata such as Multipurpose Internet Mail Extensions (MIME), computing a signature or hash over the contents, or other means. If no modification is required, processing moves to step 46 where the content is forwarded to the appropriate device or process. In the present example this would be router 14 of FIG. 1.

If at step 34 it has been determined a modification is required, processing moves to step 36 where the type of modification is selected. Process 30 illustrates four possible types of modification namely:

1) The insertion of advertising as shown at step 38;

2) The reduction of quality as shown at step 40;

3) The addition of Digital Rights Management (DRM) information as shown at step 42; and

4) The addition of tracking information as show at step 44. Steps 38, 40, 42 and 44 modify the content provided at step 32 and then provide that modified content to step 46 for distribution.

It is not the intent of the inventor to restrict the types of modification to those illustrated by steps 38, 40, 42 and 44, they serve only as examples.

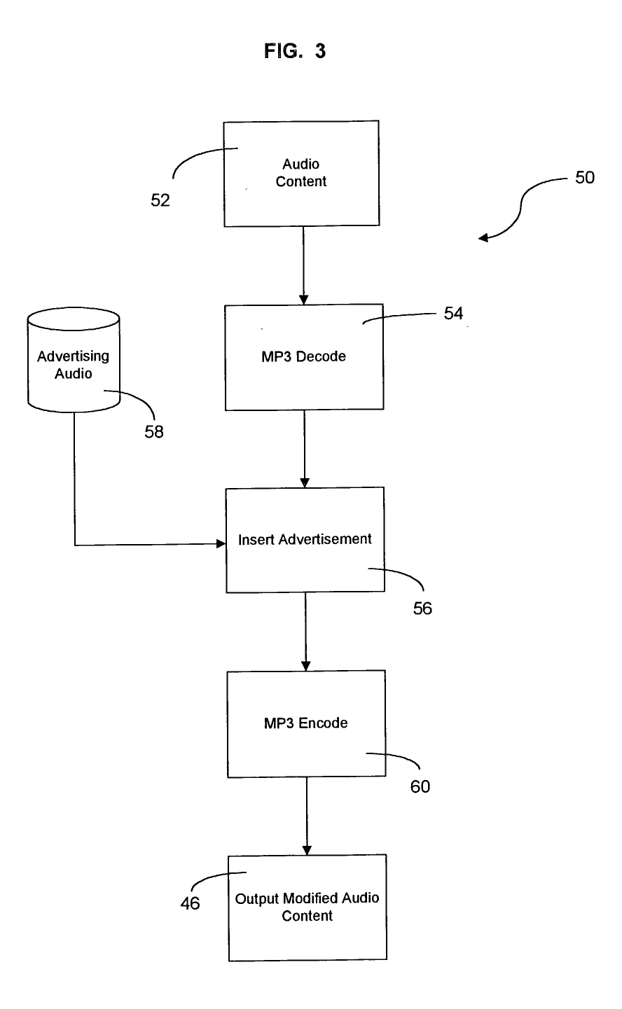

We will now discuss the functionality provided by steps 38, 40, 42 and 44 with reference to FIGS. 3, 4, 5 and 6 respectively.

Referring to FIG. 3 a logical flowchart illustrating insertion of an advertisement in an audio file is shown generally as process 50. Although this example is directed to inserting advertisements in mp3 files, a similar technique may be applied to other forms of content, such as video or electronic books.

By way of example, advertising content could be added to the ID3 textual description flag in mp3 audio. Alternatively advertising content could be pre-pended to the audio, or overlay the audio. This advertising space could be sold to pay the royalty associated with the media that is transferred, and targeted to the end-user or receiver of the content.

At step 52 the audio content is received and passed to step 54 where it is decoded. At step 56 one or more advertisements are extracted from database 58 and added to the content. The merged advertisements and content are then encoded at step 60. Once encoded the modified content is output at step 46, which is the same step 46 as shown in FIG. 2.

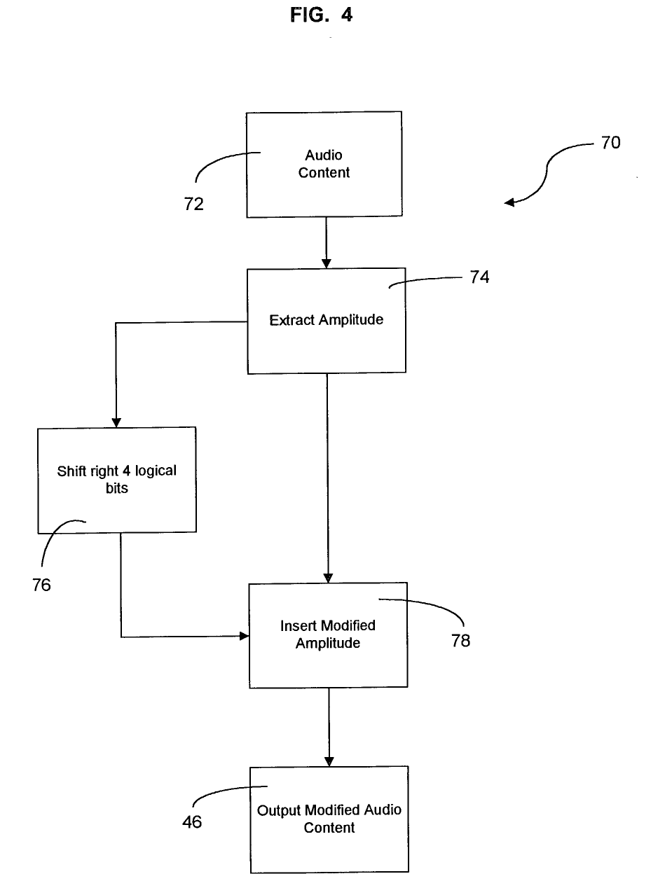

Referring now to FIG. 4 a logical flowchart illustrating audio quality reduction is shown generally as process 70. Although process 70 is directed to reducing the quality content of mp3 audio, a similar technique may be applied to other forms of content. In process 70 the audio amplitude (volume) could be truncated in precision, e.g. reduced from 16 bits to 12 bits, so that the audio sounded more “grainy” or slightly distorted. It would still be possible for a listener to determine if they liked the content, but the listener would be less inclined to record it onto a CD and listen to it later, they would be more inclined to buy the licensed and higher quality version. This may be viewed as a try-before-you buy mechanism.

Beginning at step 72 the content is received and at step 74 the amplitude of the signal is extracted. At step 76 the value of the amplitude is then shifted right 4 logical bits and passed to step 78 where the original amplitude is replaced with the modified amplitude. The resulting modified content is then output at step 46, which is the same step 46 of FIG. 2.

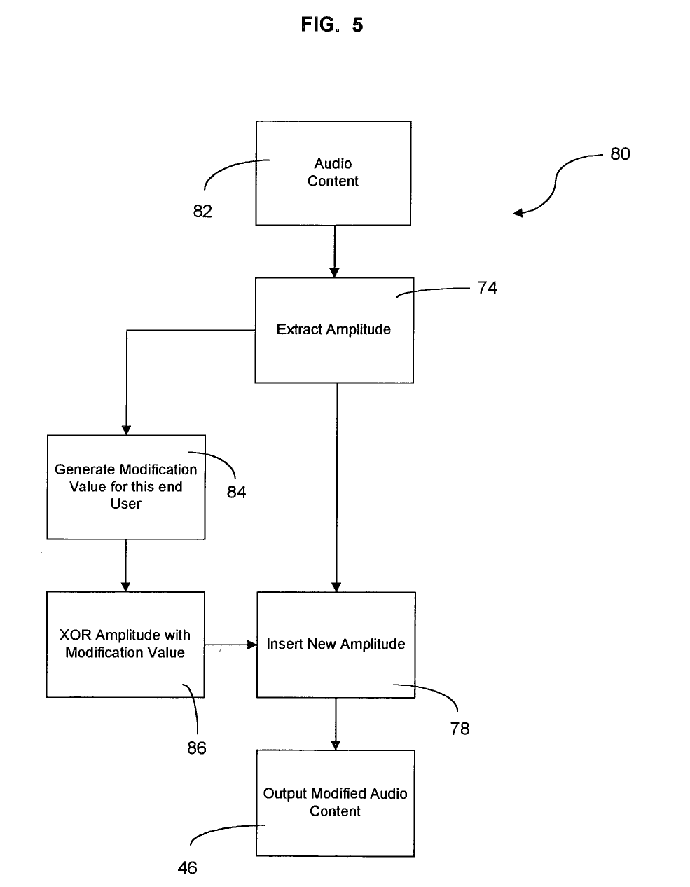

Referring now to FIG. 5 a logical flowchart illustrating insertion of digital rights management is shown generally as process 80. Continuing with our example of content being an audio file, to add digital rights management to an mp3 file, a technique could be employed where a pseudorandom number is generated. For each file transferred, each time it is transferred, a different pseudorandom number would be chosen. A mathematical function is then used to generate a modifying sequence of numbers based on the initial seed. This could be used, for example, to add audible artifacts to the amplitude as discussed early with regard to process 70. Thus, the song would still be usable, but of lower quality. For a price, the user downloading the content could obtain the random number and the inverse modifying sequence, and the already-downloaded file could be returned to its original state.

Beginning at step 82 the audio content is received and at step 74 the amplitude of the signal is extracted. This is the same step 74 of process 70 (see FIG. 4). At step 84 a random number is generated and at step 86 the random number is XORed with the amplitude. The result of step 86 is then used to replace the original amplitude in the content. This is the same step 78 of process 70 (see FIG. 4). The modified content is then output at step 46, which is the same step 46 of FIG. 2.

As one skilled in the art will recognize, a more sophisticated algorithm than a simple XOR with a generated modification value could be employed at steps 84 and 86. It is not the intent of the inventors to restrict the present invention to any specific algorithm. Process 80 is reversible by supplying the modification values to the end user to decode the content.

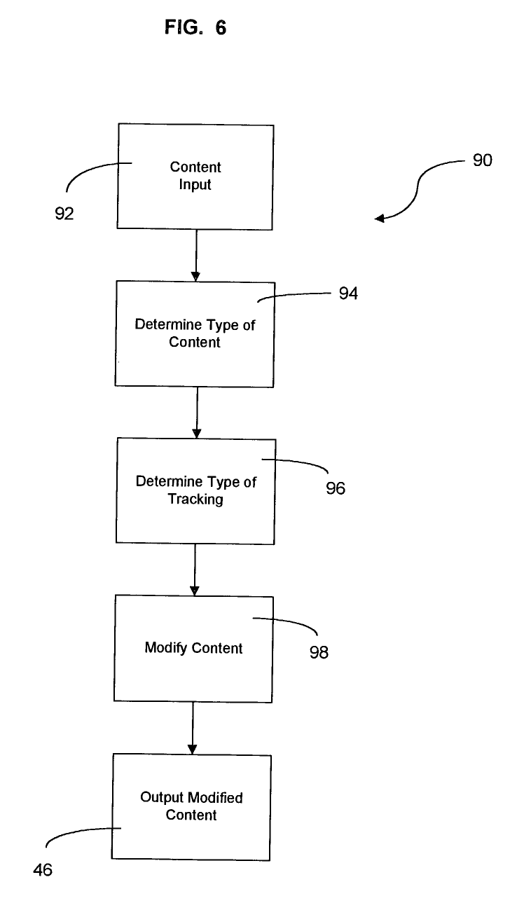

Referring now to FIG. 6 a logical flowchart illustrating insertion of tracking information is shown generally as process 90. Content is received at step 92 and passed to step 94 where the type of content is determined. As discussed herein, content may take many forms, including by not limited to: audio, video, electronic books or other material. Depending upon the type of content a decision is made at step 96 to determine what form of tracking should be introduced into the content. For example, in an mp3 file the tracking would involve the use of an ID3 tag. For mpeg files, a private PID may be utilized. Further, the tracking to be added would be application dependent and configurable. Tracking information could include: the IP addresses of the provider of the content, the time of day the content was sent out, and other data. The tracking information may be inserted in a number of content specific ways, including the use of digital watermarking techniques. At step 98 the content is modified based upon the information from steps 94 and 96 and then output at step 46 that is the same step 46 of FIG. 2.

Configuration of file modification device 18 (FIG. 1) would permit the recognition of content by numerous means, including but not limited to: name, patterns within the content, or a digital signature or computed content signatures, for example MD5 or SHA-1 hash. Configuration of device 18 would also allow making the appropriate decision for the appropriate end-user transparently and without the end-user being able to circumvent the device.

Although the present invention has been described as being a process to be implemented in software, one skilled in the art will recognize that it may be implemented in hardware as well. Further, it is the intent of the inventors to include computer readable forms of the invention. Computer readable forms meaning any stored format that may be read by a computing device.

Although the invention has been described with reference to certain specific embodiments, various modifications thereof will be apparent to those skilled in the art without departing from the spirit and scope of the invention as outlined in the claims appended hereto.

I claim

1. A file modification device for dynamically modifying content as the content transfers through a network.

2. The device of claim 1 wherein said network is a peer to peer network.

3. The device of claim 1 wherein said device comprises means for adding advertising to said content.

4. The device of claim 1 wherein said device comprises means for lowering the quality of said content

5. The device of claim 4 wherein said means for lowering the quality of said content comprises means for altering the amplitude in content containing audio.

6. The device of claim 1 wherein said device comprises means for rights management to add digital rights management to said content.

7. The device of claim 6 wherein said means for rights management comprises means for generating a random number, means for combining said random number with a portion of said content to create new content and means for combining said new content with said content.

8. The device of claim 1 wherein said device comprises means for adding tracking information to said content.

9. The device of claim 8 wherein said means for adding tracking information comprises means for determining the type of said content and means for modifying said content, said means for modifying utilizing said means for determining to select modifications to be made to said content.

10. A method for dynamically modifying content as the content transfers through a network.

11. The method of claim 10 wherein said network is a peer to peer network.

12. The method of claim 10 wherein said method comprises the steps of.
a) examining said content;
b) determining if a modification to said content is required;
c) if a modification is required, selecting the type of modification and performing the modification selected to create modified content;
d) outputting said content or said modified content.

13. The method of claim 12 wherein at step c) the type of modification is selected from the set of modifications consisting of: insertion of advertising, reduction of quality, addition of Digital Rights Management, and addition of tracking information.

14. The method of claim 13 wherein if said modification is insertion of advertising, modifying said content to include advertising in said content.

15. The method of claim 13 wherein if said modification is reduction of quality, and if said content is an audio file, utilizing means for reducing the quality of said content.

16. The method of claim 13 wherein if said modification is addition of Digital Rights Management and said content is an audio file, splitting amplitude from said content, generating a modification value, combining said modification value with said amplitude to create modified amplitude and replacing said amplitude with said modified amplitude in said content.

17. The method of claim 13 wherein if said modification is addition of tracking information, determining the type of said content, and adding tracking information into said content based upon said type of content.
